(19) United States
(12) Patent Application Publication
(10) Pub. No.: US 2026/0031554 A1
(43) Pub. Date: Jan. 29, 2026

(54) CONNECTOR TERMINAL, ELECTRICAL CONNECTION MODULE, AND CONNECTOR

(71) Applicant: Tyco Electronics (Shanghai) Co., Ltd., Shanghai (CN)

(72) Inventors: Jianfei (Fencer) Yu, Shanghai (CN); Yuquan (Kenny) Chen, Shanghai (CN); Guoqiang (David) Li, Shanghai (CN); Yong (Chris) Wang, Shanghai (CN); Xinzheng (Tony) Fan, Shanghai (CN); Daokuan (Jeremy) Zhang, Shanghai (CN)

(73) Assignee: Tyco Electronics (Shanghai) Co., Ltd., Shanghai (CN)

(21) Appl. No.: 19/277,914

(22) Filed: Jul. 23, 2025

(30) Foreign Application Priority Data
Jul. 23, 2024 (CN) 202421753699.4

(51) Int. Cl. H01R 11/11; H01R 4/36; H01R 13/03; H01R 13/432; H01R 13/6581

(52) U.S. Cl. CPC H01R 11/11; H01R 4/36; H01R 13/03; H01R 13/432; H01R 13/6581

(57) ABSTRACT

A connector terminal includes a mating portion configured to mate with a mating terminal of a mating connector. A connecting portion connected to a rear end of the mating portion for electrical connection with a wire, the connecting portion has a wire insertion hole, and a threaded hole in communication with the wire insertion hole is formed in a top wall of the connecting portion, to enable an end of the wire to be fastened in the connecting portion. The connector terminal is an integral stamped terminal that is made of a single metal plate by stamping, and the top wall of the connecting portion includes two plates stacked together, the top wall of the connecting portion has a dual-plate structure to increase a mechanical strength of the top wall of the connecting portion.

### CROSS-REFERENCE TO RELATED APPLICATIONS

This application claims the benefit of Chinese Patent Application No. CN 202421753699.4 filed on Jul. 23, 2024 in the State Intellectual Property Office of China, the whole disclosure of which is incorporated herein by reference.

### FIELD OF THE INVENTION

The present invention relates to a connector terminal, and a connector comprising the connector terminal.

### BACKGROUND

A connector terminal typically includes a mating portion configured to mate with a mating terminal and a connecting portion configured to be electrically connected to a wire. A wire insertion hole and a threaded hole are formed in the connecting portion such that the inserted wire can be fastened in the connecting portion by means of a screw that is screwed into the threaded hole. In the prior art, such connector terminals are usually machined terminals, which results in a relatively high cost of the connector terminals.

### SUMMARY

A connector terminal includes a mating portion configured to mate with a mating terminal of a mating connector. The connector terminal further includes a connecting portion connected to a rear end of the mating portion for electrical connection with a wire, the connecting portion has a wire insertion hole for insertion of one end of the wire, and a threaded hole in communication with the wire insertion hole is formed in a top wall of the connecting portion, to enable an end of the wire to be fastened in the connecting portion by means of a screw that is screwed into the threaded hole. The connector terminal is an integral stamped terminal that is made of a single metal plate by stamping, and the top wall of the connecting portion includes two plates stacked together, the top wall of the connecting portion has a dual-plate structure to increase a mechanical strength of the top wall of the connecting portion.

### BRIEF DESCRIPTION OF DRAWINGS

In the following, the present invention is described in more detail with references to the drawings in which:

FIG. 1 is perspective view of a connector terminal according to an exemplary embodiment when viewed from one side;

FIG. 2 is a perspective view of the connector terminal according to an exemplary embodiment when viewed from the other side;

FIG. 3 is a perspective view of the connector terminal according to an exemplary embodiment when viewed from a front side;

FIG. 4 is a longitudinal sectional view of the connector terminal according to an exemplary embodiment of the present invention;

FIG. 5 is a plan sectional view of the connector terminal according to an exemplary embodiment of the present invention;

FIG. 6 is a perspective view of an electrical connection module according to an exemplary embodiment of the present invention; and

FIG. 7 is an exploded view of the electrical connection module according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

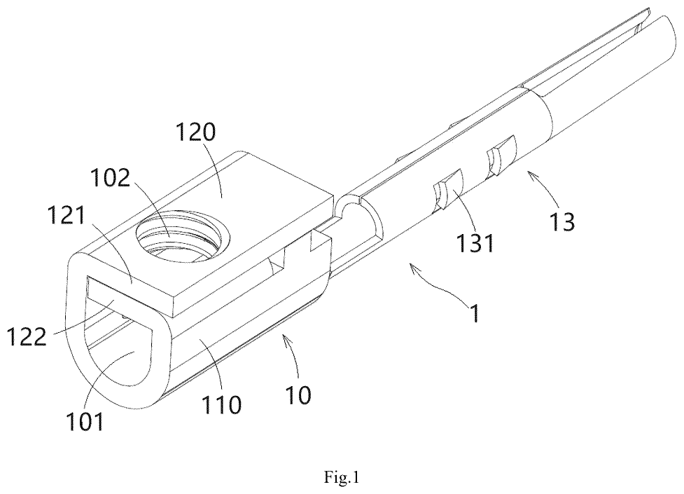

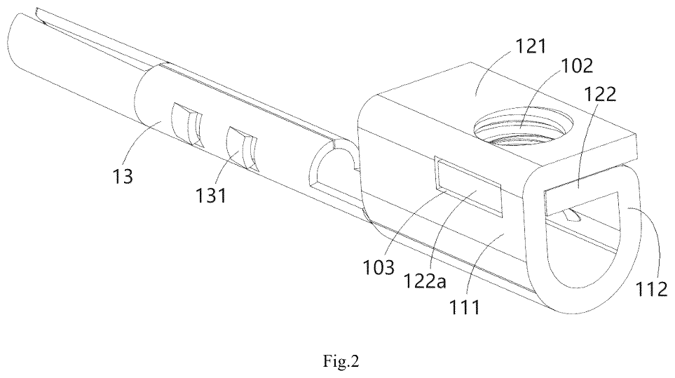

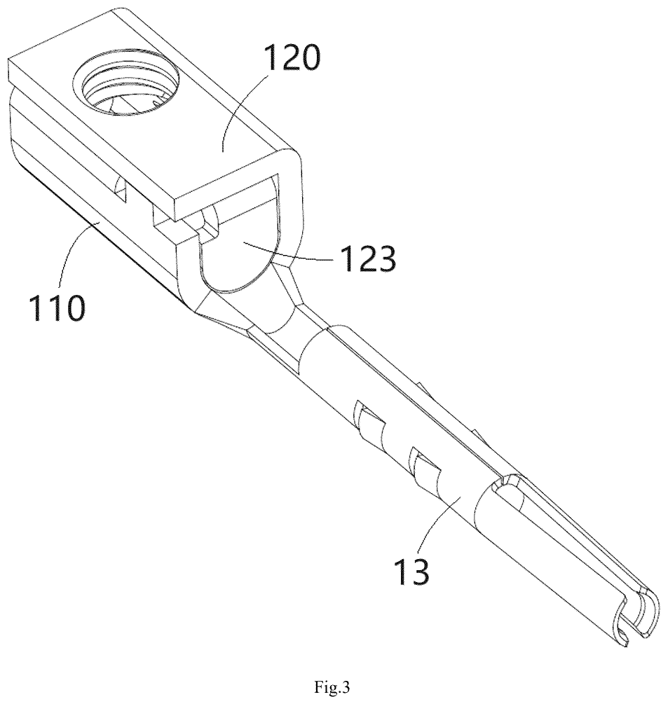

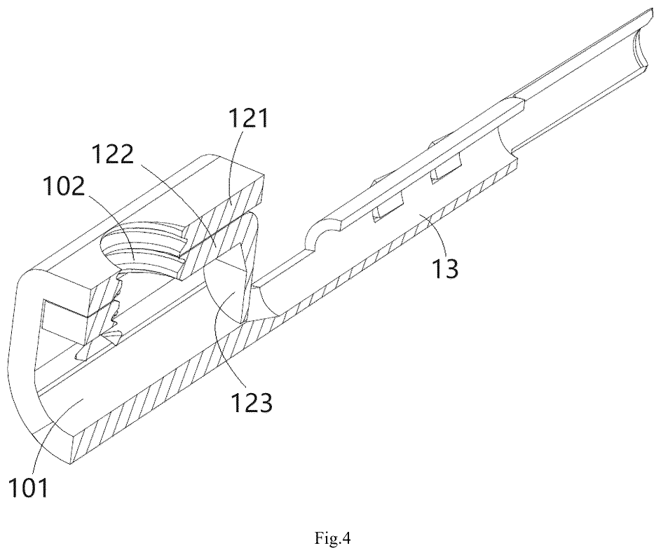

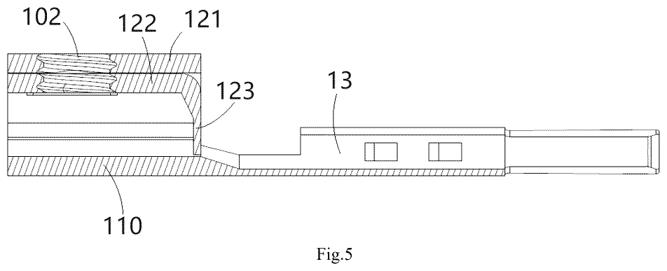

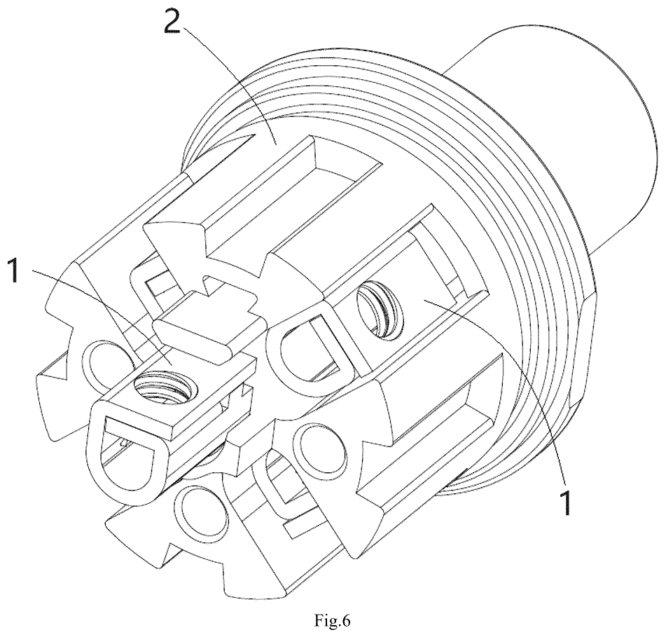

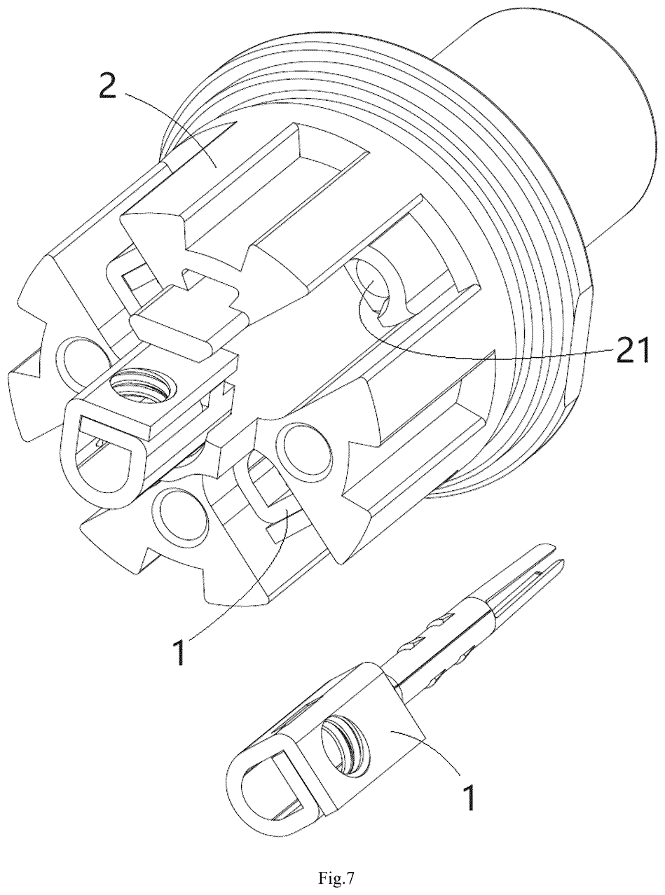

In the exemplary embodiment, as shown in FIGS. 1 to 7, in an exemplary embodiment of the present utility model, a connector terminal 1 is disclosed. The connector terminal 1 includes: a mating portion 13 and a connecting portion 10. The mating portion 13 is configured to mate with a mating terminal of a mating connector, and the connecting portion 10 is connected to a rear end of the mating portion 13 for electrical connection with a wire.

As shown in FIGS. 1 to 7, in the illustrated embodiment, the connecting portion 10 has a wire insertion hole 101 for insertion of one end of the wire, and a threaded hole 102 in communication with the wire insertion hole 101 is formed in a top wall 120 of the connecting portion 10, so as to enable the end of the wire to be fastened in the connecting portion 10 by means of a screw that is screwed into the threaded hole 102.

As shown in FIGS. 1 to 7, in the illustrated embodiment, the connector terminal 1 is an integral stamped terminal that is made of a single metal plate by stamping, and the top wall 120 of the connecting portion 10 includes two plates stacked together, so that the top wall 120 of the connecting portion 10 has a dual-plate structure to increase the mechanical strength of the top wall 120 of the connecting portion 10.

As shown in FIGS. 1 to 7, in the illustrated embodiment, the top wall 120 of the connecting portion 10 includes an upper plate 121 and a lower plate 122 which are stacked one above the other, and the upper plate 121 and the lower plate 122 are welded together.

As shown in FIGS. 1 to 7, in the illustrated embodiment, the connecting portion 10 has a U-shaped body 110, and the U-shaped body 110 has a first side wall 111 and a second side wall 112 spaced apart from and arranged opposite each other. The upper plate 121 of the top wall 120 is connected to an upper side of the first side wall 111 of the U-shaped body 110, and the lower plate 122 of the top wall 120 is connected to an upper side of the second side wall 112 of the U-shaped body 110.

As shown in FIGS. 1 to 7, in the illustrated embodiment, an insertion tongue portion 122a is formed on a side surface, facing the first side wall 111 of the U-shaped body 110, of the lower plate 122 of the top wall 120. A plug-in slot 103 is formed in the first side wall 111 of the U-shaped body 110, and the insertion tongue portion 122a engages with the plug-in slot 103 to secure the lower plate 122 of the top wall 120.

As shown in FIGS. 1 to 7, in the illustrated embodiment, a thickness of the top wall 120 of the connecting portion 10 is twice a wall thickness of the U-shaped body 110 of the connecting portion 10.

As shown in FIGS. 1 to 7, in the illustrated embodiment, the wire insertion hole 101 has a front port and a rear port opposite each other in an axial direction thereof, and the end of the wire is inserted into the wire insertion hole 101 via the rear port. The connecting portion 10 further includes a stop baffle 123. The stop baffle 123 covers the front port of the wire insertion hole 101 and is configured to abut against an end surface of an end of the wire inserted into the wire insertion hole 101 for axially positioning the wire.

As shown in FIGS. 1 to 7, in the illustrated embodiment, the stop baffle 123 is connected to a front end of the lower plate 122 of the top wall 120 and is vertically bent downward relative to the lower plate 122 of the top wall 120 into the front port of the wire insertion hole 101.

As shown in FIGS. 1 to 7, in the illustrated embodiment, the rear end of the mating portion 13 is connected to a bottom portion of a front end of the U-shaped body 110 of the connecting portion 10.

As shown in FIGS. 1 to 7, in the illustrated embodiment, the mating portion 13 is cylindrical and has a wall thickness smaller than a wall thickness of the connecting portion 10, and the mating portion 13 is configured to make electrical contact with the mating terminal inserted therein.

As shown in FIGS. 1 to 7, in the illustrated embodiment, the thickness of the top wall 120 of the connecting portion 10 is twice the wall thickness of the U-shaped body 110 of the connecting portion 10, and the wall thickness of the U-shaped body 110 of the connecting portion 10 is not less than twice the wall thickness of the mating portion 13.

As shown in FIGS. 1 to 7, in the illustrated embodiment, the metal plate includes a first plate portion for forming the mating portion 13 and a second plate portion for forming the connecting portion 10. A thickness of the first plate portion is smaller than a thickness of the second plate portion, so that the wall thickness of the mating portion 13 is smaller than the wall thickness of the connecting portion 10.

As shown in FIGS. 1 to 7, in the illustrated embodiment, a noble metal plating layer is formed on an inner peripheral surface of the mating portion 13, and the noble metal plating layer is configured to make electrical contact with the inserted mating terminal to improve the electrical contact performance.

As shown in FIGS. 1 to 7, in the illustrated embodiment, the noble metal plating layer is electroplated on the first plate portion of the metal plate before the first plate portion of the metal plate is rolled into a cylindrical shape.

As shown in FIGS. 1 to 7, in the illustrated embodiment, a locking tab 131 is formed on the mating portion 13, and the locking tab 131 extends obliquely outward and is configured to lock into a terminal insertion hole 21 of a terminal holder 2 to lock the connector terminal 1 in the terminal insertion hole 21 of the terminal holder 2.

As shown in FIGS. 1 to 7, in another exemplary embodiment of the present utility model, an electrical connection module is disclosed. The electrical connection module includes: a terminal holder 2 and a connector terminal 1. A terminal insertion hole 21 is formed in the terminal holder 2, and the connector terminal 1 is inserted into the terminal insertion hole 21 of the terminal holder 2.

As shown in FIGS. 1 to 7, in the illustrated embodiment, a plurality of terminal insertion holes 21 are formed in the terminal holder 2, and the electrical connection module includes a plurality of connector terminals 1 respectively inserted into the plurality of terminal insertion holes 21.

As shown in FIGS. 1 to 7, in another exemplary embodiment of the present utility model, a connector is disclosed. The connector includes: an electrical connection module, a shielding shell, a first nut, a second nut, and a wave spring. The shielding shell is sleeved on the terminal holder 2. The first nut is sleeved on the terminal holder 2 and is threadedly connected to one end of the shielding shell. The second nut is sleeved on the terminal holder 2 and axially opposite the first nut and is configured to be threadedly connected to a mating nut of a mating connector. The wave spring is axially compressed between the first nut and the second nut to axially electrically connect the first nut and the second nut.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present utility model are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector terminal made of a single metal plate by stamping and forming, comprising:
a mating portion configured to mate with a mating terminal of a mating connector;
a connecting portion connected to a rear end of the mating portion for electrical connection with a wire, the connecting portion having a wire insertion hole, a threaded hole formed in a top wall thereof in communication with the wire insertion hole, and a screw received in the threaded hole; and
two plates stacked together and disposed on the connecting portion.

2. The connector terminal of claim 1, wherein the top wall of the connecting portion includes an upper plate and a lower plate which are stacked one above the other, and the upper plate and the lower plate are welded together.

3. The connector terminal of claim 2, wherein the connecting portion has a U-shaped body, the U-shaped body has a first side wall and a second side wall spaced apart from and arranged opposite each other.

4. The connector terminal of claim 3, wherein the upper plate of the top wall is connected to an upper side of the first side wall of the U-shaped body, and the lower plate of the top wall is connected to an upper side of the second side wall of the U-shaped body.

5. The connector terminal of claim 4, wherein an insertion tongue portion is formed on a side surface, facing the first side wall of the U-shaped body, of the lower plate of the top wall.

6. The connector terminal of claim 5, wherein a plug-in slot is formed in the first side wall of the U-shaped body, and the insertion tongue portion engages with the plug-in slot to secure the lower plate of the top wall.

7. The connector terminal of claim 6, wherein a thickness of the top wall of the connecting portion is twice a wall thickness of the U-shaped body of the connecting portion.

8. The connector terminal of claim 4, wherein the wire insertion hole has a front port and a rear port opposite each other in an axial direction thereof, and the end of the wire is inserted into the wire insertion hole via the rear port.

9. The connector terminal of claim 8, wherein the connecting portion further includes a stop baffle, the stop baffle covering the front port of the wire insertion hole and being configured to abut against an end surface of the end of the wire inserted into the wire insertion hole for axially positioning the wire.

10. The connector terminal of claim 9, wherein the stop baffle is connected to a front end of the lower plate of the top wall and is vertically bent downward relative to the lower plate of the top wall into the front port of the wire insertion hole.

11. The connector terminal of claim 4, wherein the rear end of the mating portion is connected to a bottom portion of a front end of the U-shaped body of the connecting portion.

12. The connector terminal of claim 10, wherein the mating portion is cylindrical and has a wall thickness smaller than the wall thickness of the connecting portion, and the mating portion is configured to make electrical contact with the mating terminal inserted therein.

13. The connector terminal of claim 12, wherein a thickness of the top wall of the connecting portion is twice the wall thickness of the U-shaped body of the connecting portion, and the wall thickness of the U-shaped body of the connecting portion is not less than twice the wall thickness of the mating portion.

14. The connector terminal of claim 12, wherein a metal plate includes a first plate portion for forming the mating portion and a second plate portion for forming the connecting portion, and a thickness of the first plate portion is smaller than the thickness of the second plate portion, so that the wall thickness of the mating portion is smaller than the wall thickness of the connecting portion.

15. The connector terminal of claim 14, wherein a noble metal plating layer is formed on an inner peripheral surface of the mating portion, and the noble metal plating layer is configured to make the electrical contact with an inserted mating terminal to improve an electrical contact's performance.

16. The connector terminal of claim 15, wherein the noble metal plating layer is electroplated on the first plate portion of the metal plate before the first plate portion of the metal plate is rolled into a cylindrical shape.

17. The connector terminal according to claim 14, wherein a locking tab is formed on the mating portion, and the locking tab extends obliquely outward and is configured to lock into a terminal insertion hole of a terminal holder to lock the connector terminal in the terminal insertion hole of the terminal holder.

18. An electrical connection module, comprising:
a terminal holder in which a terminal insertion hole is formed; and
a connector terminal inserted into the terminal insertion hole of the terminal holder.

19. The electrical connection module of claim 18, wherein a plurality of terminal insertion holes are formed in the terminal holder, and the electrical connection module includes a plurality of connector terminals respectively inserted into the plurality of terminal insertion holes.

20. A connector, comprising:
an electrical connection module;
a shielding shell sleeved on a terminal holder;
a first nut sleeved on the terminal holder and threadedly connected to one end of the shielding shell;
a second nut sleeved on the terminal holder and axially opposite the first nut and configured to be threadedly connected to a mating nut of a mating connector; and
a wave spring axially compressed between the first nut and the second nut to axially electrically connect the first nut and the second nut.
